(19) United States
(12) Patent Application Publication
(10) Pub. No.: US 2017/0037205 A1
(43) Pub. Date: Feb. 9, 2017

(54) Unknown

(71) Applicant: Binderholz International AG, Wollerau (Zurichsee) (CH)

(72) Inventors: Hans Binder, Wollerau (Zurichsee) (CH); Gebhard Dünser, Dornbirn (AT)

(21) Appl. No.: 14/817,540

(22) Filed: Aug. 4, 2015

(51) Int. Cl. C08J 5/12; B32B 7/12; B32B 21/13; B32B 37/12

(52) U.S. Cl. CPC C08J 5/124; B32B 37/12; B32B 7/12; B32B 21/13; B32B 2255/08; B32B 2419/04; C08J 2397/02; C08J 2475/04

(57) ABSTRACT

The present invention relates to a method of producing wooden components, wherein in the method a first wooden slat is provided with an adhesive at at least one of its planar broad sides and/or at at least one of its narrow sides and the first wooden slat is glued to a second wooden slat to form a block of a plurality of wooden slats, wherein at least the first wooden slat is in a wet state during the gluing.

The invention relates to a method of producing wooden components in accordance with the preamble of claim 1.

It is known in the prior art to apply adhesive to wooden slats at their broad sides and to create a wooden slat block by the joining to further wooden slats. This wooden slat block is typically the starting point for the manufacture of solid and wood-based boards, laminated timber, laminated plywood, formwork boards or also support boards for the parquet industry.

It is the underlying object of the invention to further develop the method known in the prior art to achieve the same results in a less expensive and less complex manner.

This object is achieved by the method having the features of claim 1.

In accordance with the method in accordance with the invention for producing wooden components, at least one first wooden slat is provided with at least one adhesive at at least one of its broad sides and/or at at least one of its narrow sides, preferably along its longitudinal axis, and the first wooden slat is glued to a second wooden slat to form a block of a plurality of wooden slats. The method is further characterized in that at least the first wooden slat is in a wet state during the gluing.

The term “wet” is understood in accordance with the present invention as the range of wood moisture above the so-called fiber saturation point.

The fiber saturation point designates a specific state of moisture of wood. Below the fiber saturation point, moisture is only stored in the cell walls as bound water. With a moisture content above fiber saturation, wood can only have further moisture in the form of free water in the lumina of its cells, which only has a small influence on its physical and mechanical properties. If, however, the moisture content changes below the fiber saturation, this has a decisive influence on its properties, it e.g. begins to swell or to shrink. The fiber saturation point is specific to the type of wood and is between 24% and 32% wood moisture for most woods. Since the wood moisture describes the ratio of the water mass in the wood to the mass of the kiln-dried wood, the fiber saturation point can, however, by all means be above 50% wood moisture in light types of wood such as balsa wood.

The block produced by the method in accordance with the invention can only comprise wooden slats glued in a wet state. However, dry wooden slats can also be used within the framework of the method, i.e. wooden slats which are not “wet” in the sense of the present invention.

The method can be carried out such that dry and wet wooden slats can be mixed alternately or randomly.

By the gluing in a wet state, so-called wet gluing, it is not necessary in accordance with the method in accordance with the invention only to use dried wooden slats for producing wooden components, as is customary in the prior art. This reduces the storage time of the wooden slats and contributes to a cost reduction of the method overall.

The method can be carried out such that dry, wet, rough-cut, calibrated, brushed, dressed, smoothed or planed wooden slats are used which are mixed alternately or randomly.

The block comprising at least two wooden slats glued to one another is preferably separated along a plane to obtain a single-layer solid wood board. The separation of the block typically takes place in this respect in a plane which is perpendicular to the planar broad side of a wooden slat.

In accordance with another further development of the method in accordance with the invention, the block or the single-layer solid wood board obtained when separating the block is subsequently dried, with the aid of a drying apparatus preferably being made use of for this purpose.

This applies accordingly to all other boards or blocks which are formed by the separation of the block.

Since the drying is now only carried out in an already glued state of the plurality of wooden slats, it is not necessary already to supply the individual wooden slats forming the block to the process in a dried state.

The dried single-layer solid wood board or the product otherwise obtained from the wet-glued block is preferably further processed with or without a further surface machining.

In accordance with a further optional further development of the invention, the first wooden slat is a rough-cut wooden slat. The use of a rough-cut wooden slat is economically particularly advantageous since no machining steps have to be carried out at the sawing edge of the wooden slat prior to a gluing and the freshly sawn wooden slat can simply be supplied to the process in accordance with the invention after its production.

This does not only apply to the first wooden slat. The method can generally be designed such that exactly one wooden slat, a plurality of wooden slats or all the wooden slats of the block are rough-cut, smoothed, calibrated, brushed, dressed or planed.

In accordance with an embodiment of the method, polyurethane is used as the adhesive to achieve a gluing of the plurality of wooden slats to a wooden slat block. Polyurethane has proved to be a reliable adhesive for wooden slats which is inexpensive and not particularly demanding in its handling. It is particularly advantageous that polyurethane also ensures a sufficiently strong gluing of the wooden slats which are in a wet state.

The invention is, however, not restricted to the use of polyurethane as the adhesive. In general, all adhesive systems suitable for a wet gluing can be used for the wet block bonding.

The gluing of the first wooden slat to the second wooden slat is preferably a joining of the two wooden slats at their respective broad sides or at their narrow sides. It is meant by this that the wooden slat which after all respectively has two narrow sides, broad sides and end faces is joined to another broad side or narrow side of a further wooden slat by means of the adhesive. The two wooden slats are typically pressed to one another. This can take place in a press.

The adhesive is preferably applied over the full surface at the broad side and/or at the narrow side of the first wooden slat and/or further wooden slats. It is, however, also conceivable in this respect that the adhesive is only applied to certain zones of the broad side and/or of the narrow side, for example a marginal zone of the broad side and/or of the narrow side is not provided with adhesive since the adhesive is typically moved into these marginal zones by the pressure between the two wooden slats on the pressing of the first wooden slat onto the second wooden slat. An omission of these marginal zones counteracts a squeezing out of the adhesive toward the narrow sides or toward the end faces of the two wooden slats pressed together.

In accordance with a further modification of the method in accordance with the invention, the separation of the block is a sawing which can take place by means of a band saw or a buzz saw. Other sawing and separating methods are also conceivable and covered by the invention.

It is furthermore conceivable that the block has a length, wherein the wooden slats used for producing the block likewise have this length or are composed of shorter wooden slats which are shorter than the named length and whose end faces are adjacent to one another with or without gluing.

The individual layers of the blocks can, but thus do not have to, comprise wooden slats in full block length, i.e. “single-piece” wooden slats. The layers can also be composed of shorter wooden slats, i.e. of wooden slats whose lengths are smaller than that of the block.

The end faces of these shorter wooden slats can form a butt joint with one another or can abut one another with a finger jointing. Other shapes of the end faces are also conceivable and covered by the invention.

The butt jointing or finger jointing, etc. can take place without or also with adhesive application between the end faces.

The block can comprise in an embodiment only one wooden slat or also a plurality of wooden slats in the thickness direction, the narrow sides of the wooden slats being adjacent to one another with or without gluing. I.e. in an embodiment, the block only comprises wooden slats which are connected to one another via their broad sides; in another embodiment it only comprises wooden slats which are connected to one another via the narrow sides; and in a further embodiment wooden slats which are connected to one another via their narrow sides and their broad sides.

The wooden slats adjacent to one another at the narrow sides are also called wooden slats disposed next to one another within the framework of the present invention.

The narrow sides of the wooden slats disposed next to one another can form a butt joint with one another or can be connected to one another by a finger jointing.

Other profiles of the narrow sides and/or of the end faces of the wooden slats are conceivable and are also covered by the invention such as a keyway formwork, a rabbet joint formwork or a Vee joint formwork or a tongue and groove profile. Other cut or sawn profiles are also covered by the invention.

The invention furthermore also comprises a wooden component for whose production a method in accordance with one of the preceding claims has been used.

Further features of the invention will be explained in more detail with reference to an embodiment shown in the drawing. There are shown:

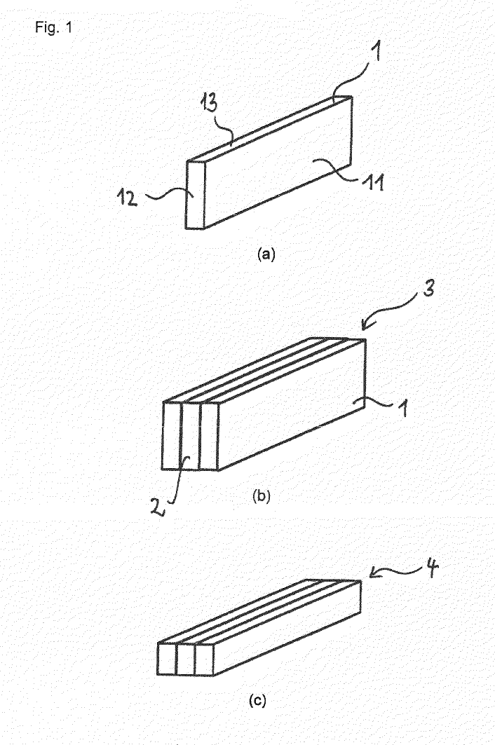

FIG. 1: an illustration of the method in accordance with the invention with reference to three steps to achieve a single-layer solid wooden board starting from a wooden slat;

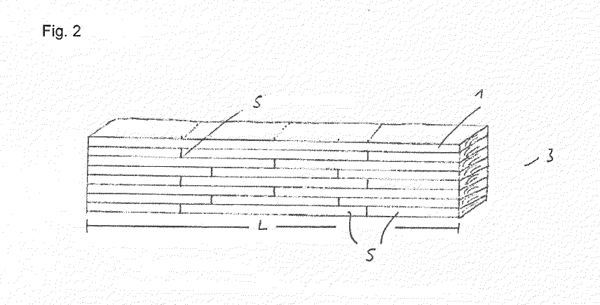

FIG. 2: a perspective view of a block with slats connected by a butt joint;

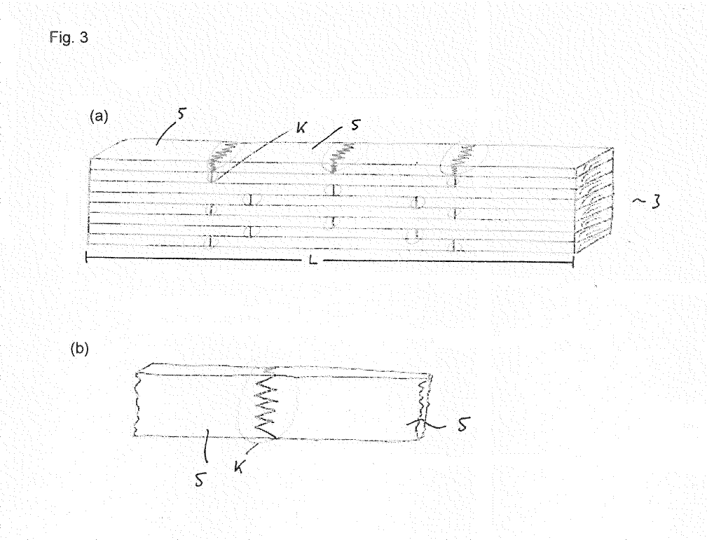

FIG. 3 a perspective view of a block with slats connected via finger jointing and a detailed representation of the finger jointing;

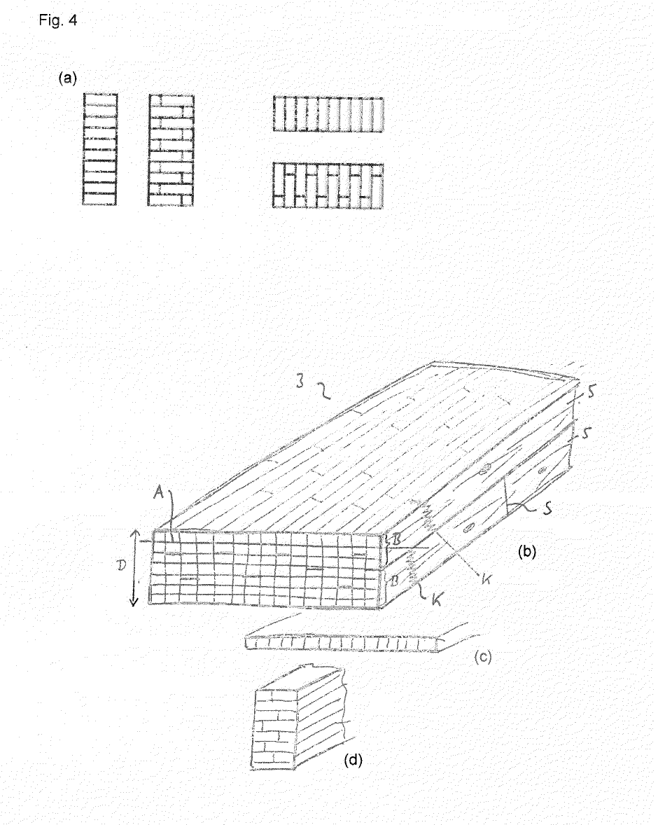

FIG. 4: a perspective view of a block with slats disposed next to one another as well as views of the block at its end face and views of a solid wood board cut from the block and of a block; and

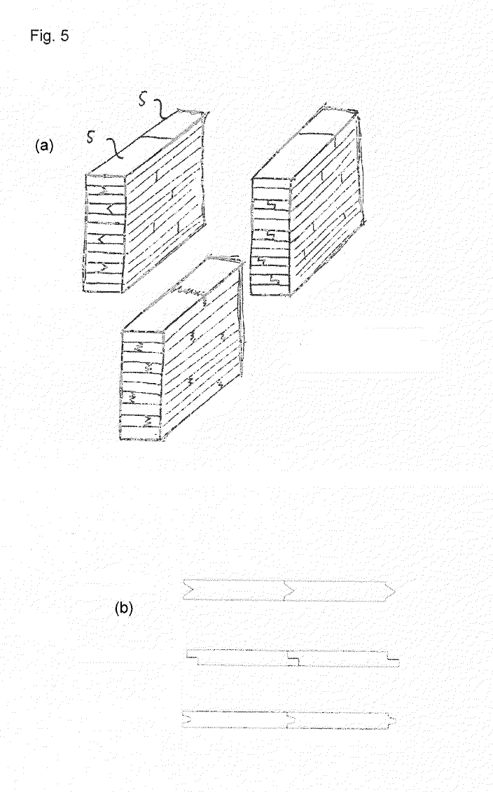

FIG. 5: perspective views of blocks with differently designed narrow sides and their detailed representations.

FIG. 1 (a) in this respect shows a wooden slat 1, with its broad side 11, the narrow side 13 and the end face 12. The broad side 11 and the narrow side 13 are in this respect aligned in parallel with the longitudinal direction of the slat 1. The end face surface 12 is perpendicular to the longitudinal direction of the wooden slat 1. The wooden slat is typically sawed from a tree trunk.

The wooden slat 1 is now glued in a wet state to a block 3 having a plurality of wooden slats 1 with the aid of an adhesive. For this purpose, adhesive is applied to the broad side or to the broad side surface 11 of the wooden slat 1 and a second wooden slat 2 is then joined thereto. Unlike the prior art, a wet gluing is carried out here, that is the wooden slat is not first subjected to a drying procedure or it is not waited until the wooden slat has become dry on its own.

FIG. 1 (b) shows a block 3 composed of a plurality of wooden slats 1, 2.

It is important for the invention in this respect that the gluing of the wooden slats 1, 2 to produce the block 3 takes place in a wet state of the first wooden slat 1 and/or of the second wooden slat 2 joined thereto since the above-listed advantages can hereby be achieved.

FIG. 1 (c) shows a single-layer solid wooden board 4 which is obtained by separating the block 3.

The separating or sawing of the block 3 substantially takes place such that the block 3 is removed slice by slice. In this respect, the separation plane is not in parallel with the broad side 11 of a single wooden slat 1, 2. In the embodiment shown in FIG. 1 (c), the separation plane is oriented perpendicular to the broad side 11 of a wooden slat 1,2.

The single-layer solid wood boards 4 obtained after the separation of the block 3 can subsequently be dried. After the drying, the single-layer solid wood boards 4 are further processed to corresponding solid wood products. It can in this respect be single-layer boards and multilayer boards, board plywood or other glued wood products.

The main advantage of the invention is based on the gluing of the individual wooden slats in the wet state. Wet state here means the use of a wooden slat 1, 2 which is not completely dried.

FIG. 2 shows a block 3 which has slats 1 which extend over the full block length L and which also has slats 5 which are shorter.

These shorter slats 5 can form a butt joint with one another at the end faces of the slats 5 so that butt joints S are created.

An adhesive can be used between the butt joints adjoining one another; however, a forming of the butt joints S without adhesive is also conceivable.

The lengths of the slats 5 can e.g. be ¼, ½, ¼ or ⅓, ⅓, ⅓ etc. so that a full block length L results in sum.

The butt joints S are preferably offset from one another as can be seen from FIG. 2.

FIG. 3 (a) likewise shows a block 3 which has slats 5 which are shorter than the full block length L.

These shorter slats 5 are connected at their end faces by a finger jointing K such as can be seen from FIG. 3.

An adhesive can be used between the end faces of the slats 5 connected via a finger jointing K; however, it is also conceivable to form the finger jointing K without adhesive.

The lengths of the slats 5 can e.g. be ¼, ½, ¼ or ⅓, ⅓, ⅓ etc. so that a full block length L results in sum. The use of slats extending over the total block length L is also conceivable.

FIG. 3 (b) shows the area of the finger jointing between two slats 5 in an enlarged representation.

A block design can be seen from FIG. 4 having slats disposed next to one another, i.e. connected to one another at the narrow sides 13.

Whereas FIGS. 1 to 3 relate to block designs from one layer of slats whose broad sides are connected to one another, FIG. 4 shows an embodiment in which the slats are not only connected to adjacent slats at their broad sides, but also at their narrow sides.

FIG. 4 (b) shows a block 3 which has a thickness D which results from the sum of the width B of two slats 5. The slats 5 can be connected to one another at the end face by means of a butt joint S and/or by means of a finger jointing K.

A block which is produced using the method in accordance with the invention can generally only comprise slats which extend over the total block length L, shorter slats adjacent to one another at the end face or a combination of both types of slats.

FIG. 4(a) shows the end faces of different blocks which are either only made up of slats which are connected at their broad sides or of slats which are connected both at their broad sides and at their narrow sides.

A block is also covered by the invention which is only made up of slats which are only connected to one another via the narrow sides.

If slats are used which are connected to one another at their narrow sides, they can have an identical width B or different widths B.

The term “connected” within the framework of the present invention covers both the case in which the slats are connected to one another via a bonded connection and the case in which they are in contact with one another without a bonded connection.

FIG. 4(c) shows a 1-layer solid wooden board which was obtained in that the block 3 in accordance with FIG. 4 (b) was sawed along the lines A.

FIG. 4(d) shows a block which was obtained in that the block 3 in accordance with FIG. 4 (b) was separated in a direction perpendicular thereto.

The slats 5 disposed next to one another in accordance with FIG. 4 (b) can form a butt joint with one another in the longitudinal direction with or without adhesive at their narrow sides or can be connected by a finger jointing, not shown.

FIG. 5 (a) shows possible profile shapes of the narrow sides of the slats and FIG. 5 (b) shows a detailed view of the connection points of the slats.

The slats 5 can be connected in the longitudinal direction at the narrow sides by means of a cut or sawn profile, e.g. tongue and groove, Vee joint formwork (FIG. 5 (b), bottom), keyway formwork (FIG. 5 (b), top), rabbet joint formwork (FIG. 5 (b), middle) or other profile shapes with or without adhesive.

1. A method of producing wooden components, wherein:
a first wooden slat (1) is provided with an adhesive at at least at one of its planar broad sides (11) and/or at least at one of its narrow sides (13),
the first wooden slat (1) is glued to a second wooden slat (2) to form a block (3) of a plurality of wooden slats (1, 2), and
at least the first wooden slat (1) is in a wet state during the gluing.

2. A method in accordance with claim 1, wherein the block (3) is separated along a plane which preferably extents substantially perpendicular to the planar broad side (11) of the first wooden salt (1) to obtain a single-layer solid wood board (4).

3. A method in accordance with claim 1, wherein the block (3) or the single-layer solid wood board (4) is subsequently dried, preferably with the aid of a drying apparatus.

4. A method in accordance with claim 3, wherein the dried single-layer solid wood board (4) is further processed with or without further surface machining.

5. A method in accordance with claim 1, wherein one, more or all the wooden slats (1, 2) forming the block (3) are rough-cut, calibrated, brushed, dressed, smoothed or planed wooden slats (1, 2).

6. A method in accordance with claim 1, wherein all, a plurality of or only one of the wooden slats (1, 2) forming the block (3) are in a wet state during gluing.

7. A method in accordance with claim 1, wherein polyurethane or another adhesive suitable for wet gluing is used as the adhesive.

8. A method in accordance with claim 1, wherein the gluing of the first wooden slat (1) to the second wooden slat (2) is a joining of the two wooden slats (1, 2) at their respective broad sides (11) and/or at their respective narrow sides (13).

9. A method in accordance with claim 1, wherein the adhesive is applied over the full surfaces at the broad side (11) and/or at the narrow side (13) of the first wooden slat (1).

10. A method in accordance with claim 1, wherein the separation of the block (3) is a sawing which takes place by a band saw or a buzz saw.

11. A method in accordance with claim 1, wherein the block (3 has a length (L); and the wooden slats (1, 2) used for the manufacture of the block (3) have this length (L) or are composed of shorter wooden slats (5) which are shorter than the named length (L) and whose end faces (12) are adjacent to one another with or without gluing.

12. A method in accordance with claim 11, wherein the end faces (12) of the shorter wooden slats (5) form a butt joint with one another or are connected to one another by a finger jointing.

13. A method in accordance with claim 1, wherein the block (3) only comprises one (1, 2) or a plurality of wooden slats (6, 7) in the thickness direction whose narrow sides (13) are adjacent to one another with or without gluing.

14. A method in accordance with claim 13, wherein the narrow sides (13) of the wooden slats (6, 7) disposed adjacent to one another form a butt joint with one another or are connected to one another by of a finger jointing.

15. A wooden component produced by a method in accordance with claim 1.

16. A method in accordance with claim 2, wherein the block (3) or the single-layer solid wood board (4) is subsequently dried, preferably with the aid of a drying apparatus.

17. A method in accordance with claim 16, wherein the dried single-layer solid wood board (4) is further processed with or without further surface machining.

18. A method in accordance with claim 17, wherein one, more or all the wooden slats (1, 2) forming the block (3) are rough-cut, calibrated, brushed, dressed, smoothed or planed wooden slats (1, 2).

19. A method in accordance with claim 16, wherein one, more or all the wooden slats (1, 2) forming the block (3) are rough-cut, calibrated, brushed. dressed, smoothed or planed wooden slats (1 2).

20. A method in accordance with claim 4, wherein one, more or all the wooden slats (1, 2) forming the block (3) are rough-cut, calibrated, brushed, dressed, smoothed or planed wooden slats (1, 2).
